(19) United States
(12) Patent Application Publication
(10) Pub. No.: US 2012/0003618 A1
(43) Pub. Date: Jan. 5, 2012

(54) Geo-meter graph reader learning system

(75) Inventor: Elaine Frances Harold-Robinson, Teaneck, NJ (US)

(73) Assignee: Elaine Frances Harold-Robinson, Teaneck, NJ (US)

(21) Appl. No.: 13/135,083

(22) Filed: Jun. 25, 2011

Related U.S. Application Data
(60) Provisional application No. 61/398,577, filed on Jun. 29, 2010.

(51) Int. Cl. G09B 1/00

(52) U.S. Cl. 434/205

(57) ABSTRACT

The Geo-Meter Graph Reader Learning System comprises a set of physical tools and methods of usage and instruction that aid in the construction and interpretation of graphs, lines, arcs, circles and angles. The physical aspect of the system consists of three components. A first component encompasses customary and metric scales so that the system can be used with all standard graph paper. A second component may be used alone or with the first component when aligning a value on one axis with a value on another axis. A third component, used alone or with the first component, measures angles, constructs arcs and circles, and determines trigonometric values of angles. The Geo-Meter Graph Reader Learning System aids students in, a) constructing and interpreting coordinate, bar, line and circle graphs, b) expressing and determining linear relationships graphically, c) determination of increment size and value, and d) determining the slope and of lines.

This application claims the benefit of U.S. Provisional Application No. 61/398,577, filed Jun. 29, 2010, which is herein incorporated by reference in its entirety.

### TECHNICAL FIELD

This invention relates to a tool to help students understand relationships and data displayed in graphic representations.

### BACKGROUND

We all know that we remember things better in math when we understand the “why” behind the concepts. Math education should be more than memorizing a set of algorithms that help you perform a task. Often when students are learning how to read and interpret graphs, it is difficult for them to see how the information on the graph relates to the information on the axis. Disadvantageously, students have difficulty understanding that there is a relationship between the dependant and independent variables. For example, as the independent variable increases, what is happening to the dependant variable and what values of each correspond to one another at any given point? Also disadvantageously, a technique does not exist that helps younger students to easily see and interpret theses relationships and values.

### SUMMARY

Apparatuses are provided for a Geo-Meter Graph Reader Learning System. Embodiments are provided that may assist students to read and interpret graphs.

More specifically, in one embodiment, provided is an apparatus that includes a L-shaped tool for constructing and interpreting graphs, wherein the L-shaped tool has a vertical axis connected to a horizontal axis at an adjoining vertex, and wherein the vertical axis and the horizontal axis are subdivided in measured increments.

In another embodiment, an apparatus includes a first L-shaped tool that has a vertical axis connected to a horizontal axis at an adjoining vertex, wherein the vertical axis and the horizontal axis are subdivided in measured increments; a second L-shaped tool configured to work alone or in conjunction with the first L-shaped tool, wherein vertical and horizontal axes of the second L-shaped tool are not subdivided in measured increments; and a circular shaped tool configured to work alone or in conjunction with the first L-shaped tool, wherein the circular shaped tool has measured edge markings distributed along a circumference of the circular shaped tool.

In another embodiment, an apparatus includes a circular shaped tool that has measured edge markings distributed along a circumference of the circular shaped tool; and one or more radius lines that extend from a center of the circular tool to one or more of the measured edge markings, wherein at least one of the one or more radius lines is divided into spacings for at least two indicators for angle measure of degrees, sine, cosine, and tangent readings.

### DESCRIPTION OF THE DRAWINGS

Some embodiments of apparatuses in accordance with embodiments of the present invention are now described, by way of example only, and with reference to the accompanying drawings, in which:

FIG. 1 shows an illustrative embodiment of an exemplary Geo-Meter Graph Reader Learning System arranged in accordance with the principles of the invention;

FIG. 2 shows another illustrative embodiment for an exemplary Geo-Meter Graph Reader Learning System arranged in accordance with the principles of the invention;

FIG. 3 shows yet another illustrative embodiment for an exemplary Geo-Meter Graph Reader Learning System arranged in accordance with the principles of the invention; and

FIG. 4 shows an illustrative embodiment for an exemplary Geo-Meter Graph Reader Learning System arranged in accordance with the principles of the invention when component A is used in conjunction with components B and C.

### DETAILED DESCRIPTION

Embodiments are provided that address the structure and operation of a Geo-Meter Graph Reader Learning System. The Geo-Meter Graph Reader Learning System comprises a set of physical tools and methods of usage and instruction that aid in the construction and interpretation of graphs, lines, arcs, circles and angles. The Geo-Meter Graph Reader Learning System is composed of three components (i.e., component A, component B and component C) that may be used alone or in combination.

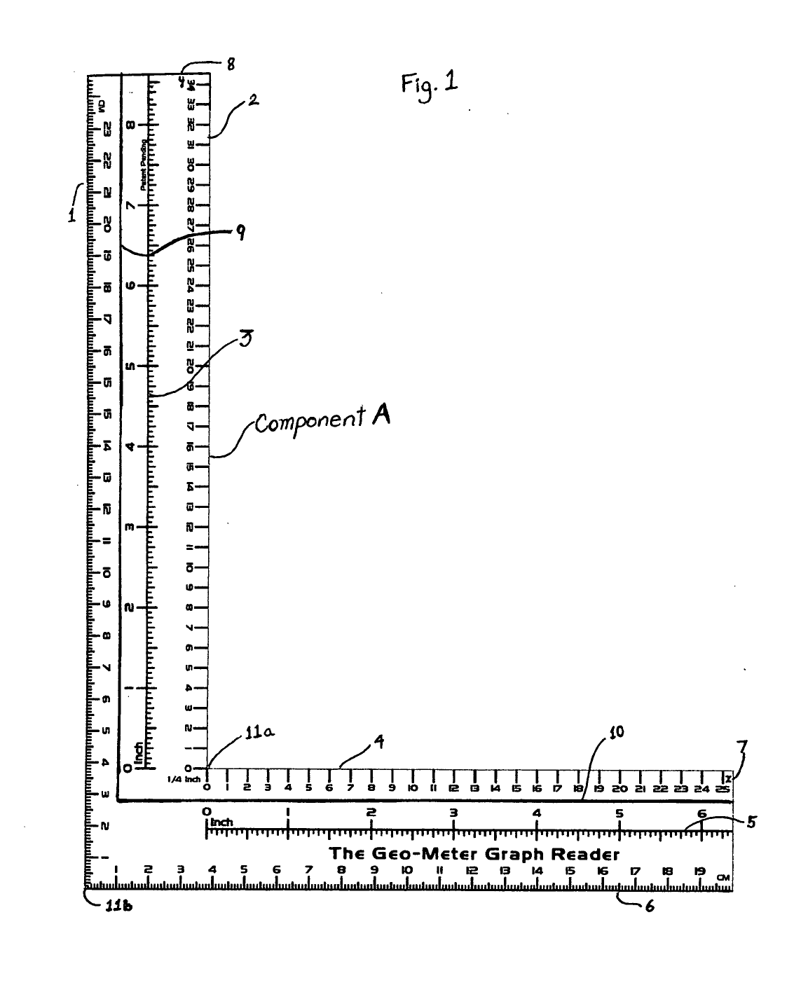

FIG. 1 shows an illustrative embodiment of an exemplary Geo-Meter Graph Reader Learning System tool arranged in accordance with the principles of the invention. As shown in FIG. 1, component A of the Geo-Meter Graph Reader Learning System tool is a L-shaped tool that has a vertical axis (i.e., y-axis) connected to a horizontal axis (i.e., x-axis) at an adjoining vertex. An outer edge 1 of the front side of the vertical axis (i.e., y-axis) of component A is subdivided in centimeters, beginning at 0 centimeters and extending to 25 centimeters. A middle portion 3 of the front side of the vertical axis (i.e., y-axis) of component A is subdivided in inches, beginning at 0 inches and extending to 8.5 inches. Inch ruler markings for the middle portion of the front side of the vertical axis are 1/16 inch increments. An inner edge 2 of the front side of the vertical axis (i.e., y-axis) of component A is subdivided in one-quarter inches, beginning at 0 and extending to 34 one-quarter inches. The vertical axis of component A is 1½ inches in width. The vertical axis of component A may have an optional vertical magnet strip 9 positioned between the outer edge 1 and the middle portion 3. Optional vertical magnet strip 9 may be used to connect component A to component B.

A first edge 6 of the front side of the horizontal axis (i.e., x-axis) of component A is subdivided in centimeters, beginning at 0 centimeters and extending to 20 centimeters. A middle portion 5 of the front side of the horizontal axis (i.e., x-axis) of component A is subdivided in inches, beginning at 0 inches and extending to 6.5 inches. Inch ruler markings for the middle portion 5 of the front side of the horizontal axis are 1/16 inch increments. An inner edge 7 of the front side of the vertical axis (i.e., y-axis) of component A is subdivided in one-quarter inches, beginning at 0 and extending to 25 one-quarter inches. The ranges of either axis of component A are exemplary, and either side may extend below or beyond the stated ranges. The horizontal axis of component A is 1½ inches in width. The horizontal axis of component A may have an optional vertical magnet strip positioned between the first edge 6 and the middle portion 5. Similar to the vertical axis, the optional vertical magnet strip of the horizontal axis may be used to connect component A to component B.

The customary inch and metric scales of component A may allow component A to be used with all standard graph paper.

In operation, in determining the size and value of the increments needed to make a graph look good and appear accurate, place component A on the graph with the vertex 11a (i.e., the inner vertex for customary graph paper) and vertex 11b (i.e., the outer vertex for metric graph paper) at the origin of the graph and the legs on the x and y axis. Component A will indicate how many grid lines there are from the origin to the end of the drawn axis. Divide the number of grid lines into the largest value that will need to be displayed on that axis. The quotient indicates the minimum value needed for each increment indicated by the grid lines, in order to have all of the data displayed on the graph. If the quotient is not an easy number to work with, simply round the quotient up to the nearest “easy” number to work with. Making the increments a bit larger than needed will give the student a bit of extra space on the axis and may make it a bit easier to plot the points. Note that it is not necessary to place a tick mark or value at each grid line in order for the value to be valid. For instance, if you want each grid line to have the value of 10, then you may skip grid lines numbering the tick marks in increments of 20. If you want to check to make sure that your increment value is adequate, then multiply the rounded increment value by the number of grid lines indicated on your graph reader. If the product is greater than or equal to the largest number in your data set for that particular axis, then your values will work well.

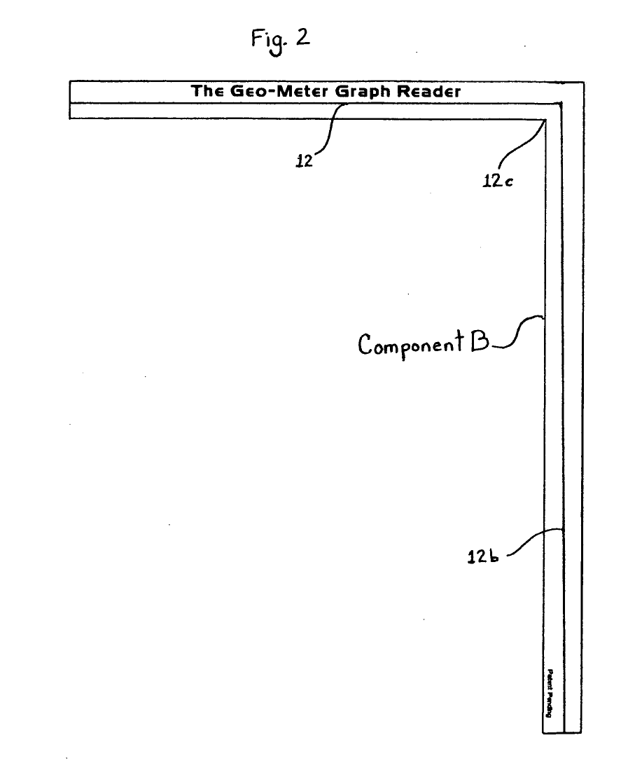

FIG. 2 shows another illustrative embodiment for an exemplary Geo-Meter Graph Reader Learning System arranged in accordance with the principles of the invention. As shown in FIG. 2, component B of the Geo-Meter Graph Reader Learning System tool is an inverted L-shaped tool that has a vertical axis (i.e., y-axis) connected to a horizontal axis (i.e., x-axis) at an adjoining vertex. Each axis of component B is ½ inch in width. The vertical axis is 22 centimeters in length and the horizontal axis is 17 centimeters in length. As stated hereinabove, component B may be used alone or in conjunction with component A, specifically when aligning a value on one axis with a value on another axis. The vertical axis and the horizontal axis of component B may have an optional vertical magnet strip 12 positioned in the center of component B. Optional vertical magnet strip 12 may be used to connect the horizontal end of component B to the vertical end of component A and the vertical end of component B to the horizontal end of component A. As shown in FIG. 2, component B differs from component A in that component B does not contain measured edge markings.

In operation, in determining the slope of a line, for a positive slope, place the vertex 11a (i.e., the inner vertex for customary graph paper) and vertex 11b (i.e., the outer vertex for metric graph paper) of the component A on the point where the line crosses the y axis. Place the vertex 12c of component B on a point on the line that goes through one of the cross hairs on the grid. The legs of component B will extend over to the graph reader displaying the x and y values to use in determining slope. For a negative slope, place the component A on the graph so that the line intersects the graph reader on both the x and y legs. The line will pass through component A at the values you need to use in order to determine slope.

Also in operation, reading and interpreting graph coordinates my be performed by placing the vertex 12c of component B on a point on the line, the axes of component B (i.e., the L) will extend to both the x and y axis. The axes of component B will intersect the axis at the data that relates to the point on the graph that the vertex is on. When trying to determine which value from one axis corresponds to a given value from another, place one of the axes of component B on the given value and slide component B so that the vertex 12c is on the line. The axis of component B will pass through the corresponding value that is to be determined.

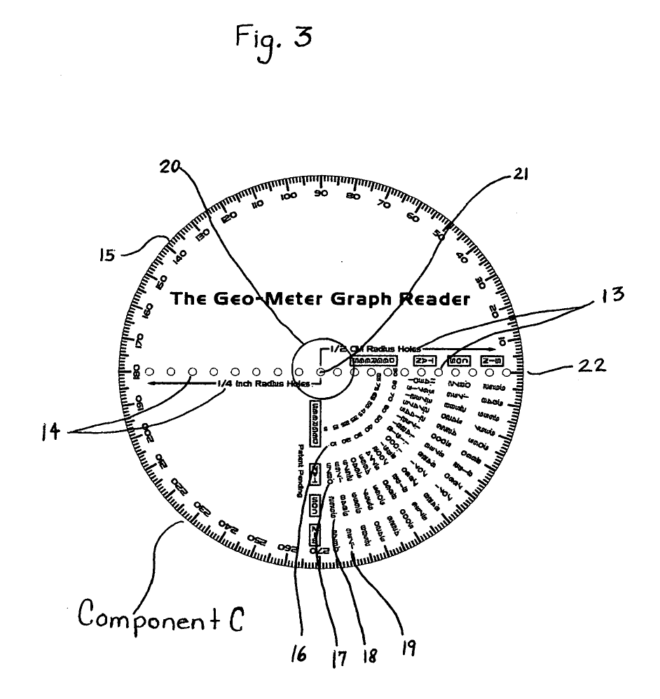

FIG. 3 shows yet another illustrative embodiment for an exemplary Geo-Meter Graph Reader Learning System arranged in accordance with the principles of the invention. As shown in FIG. 3, component C is a circular shaped tool that has measured edge markings distributed along a circumference of the circular shaped tool. The measured edge markings are indicators for measuring degrees, inches, centimeters, sine, cosine, and tangent ratios. Component C has one or more radius lines that extend from a center of the circular tool to one or more of the measured edge markings. The one or more radius lines are divided into spacings for at least two ¼ inch radius holes or ½ centimeter radius holes that are equi-distance apart. Illustratively, a first radius line that extends to the left of the center of the circular tool may be divided into spacings for two or more ¼ inch radius holes that are equi-distance apart. Also illustratively, a second radius line that extends to the right of the center of the circular tool may be divided into spacings for two or more ½ centimeter radius holes that are equi-distance apart. Component C has a circular hole 21 at a center of the circular shaped tool. Also, component C has a diameter of 6 centimeters. Component C may be used alone or in conjunction with component A to measure angles, construct arcs and circles, and determine trigonometric values of angles.

Component C may assist in measuring angles, as it can measure angles up to 270° and indicate the sine, cosine, and tangent of angles of 0° to 90° in 5° increments. In addition, component C may be used to draw circles (e.g., radius less than 2 inches with ¼ inch increments and radius less than 6 centimeters with ½ centimeter increments).

In operation, component C may be used to measure angles by placing the initial side indicator 22 of component C on the initial side of the angle to be measured with the center hole 21 of component C at the vertex of the angle to be measured. The terminal side of the angle to be measured will pass through the value on component C that corresponds to the measurement of the angle.

Component C may be used to measure the sine, cosine and tangent of an angle by using the section of component C that indicates trigonometric values as shown in FIG. 3. The terminal side of the angle to be measured will pass through component C indicating the size of the angle 16 and the corresponding sine 19, cosine 18, and tangent 17 values.

Component C may be used to draw circles by placing the center hole 21 of component C on the paper where you want the center of the circle to be located. Place a pen or pencil in the center hole 21 of component C to anchor component C. Place a second pencil in the hole (e.g., hole 13 or 14) of component C that corresponds with your desired radius. Swivel the pencil around in a circular motion until the circle is complete.

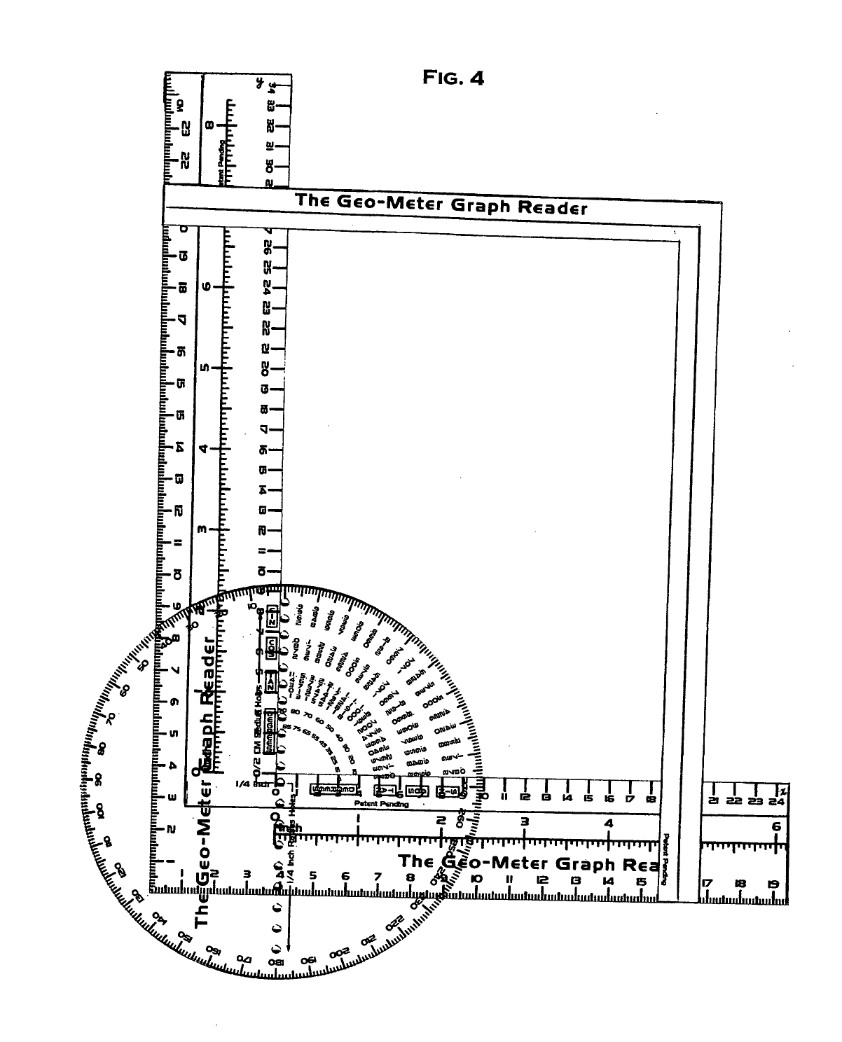

FIG. 4 shows an illustrative embodiment for an exemplary Geo-Meter Graph Reader Learning System arranged in accordance with the principles of the invention when component A is used in conjunction with components B and C.

Advantageously, the Geo-Meter Graph Reader Learning System aids students in reading and interpreting coordinate, bar, line and circle graphs and may replace protractors, angle rulers, and compasses. During coordinate and bar graph construction, the Geo-Meter Graph Reader Learning System assists in the determination of increment size and value. This system supports students who are learning how to express linear relationships graphically and with equations by helping them clearly determine the slope and y-intercept of the line. This learning system is designed to facilitate comprehension of concepts that will ultimately lead to non dependence of tools.

The steps or operations described herein are intended as examples. There may be many variations to these steps or operations without departing from the spirit of the invention. For instance, the steps may be performed in a different order, or steps may be added, deleted, or modified.

The present invention may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

The foregoing merely illustrates the embodiments of the invention. It will thus be appreciated that those skilled in the art will be able to devise various arrangements, which, although not explicitly described or shown herein, embody the principles of the invention, and are included within its spirit and scope.

What is claimed:

1. An apparatus comprising:
a L-shaped tool for constructing and interpreting graphs, wherein the L-shaped tool has a vertical axis connected to a horizontal axis at an adjoining vertex, and wherein the vertical axis and the horizontal axis are subdivided in measured increments.

2. The apparatus of claim 1 wherein an outer edge of a front side of the vertical axis is subdivided in centimeters.

3. The apparatus of claim 2 wherein the outer edge of the front side of the vertical axis is subdivided in centimeters that range from zero centimeters to at least 25 centimeters.

4. The apparatus of claim 1 wherein a middle portion of a front side of the vertical axis is subdivided in inches.

5. The apparatus of claim 4 wherein the middle portion of the front side of the vertical axis is subdivided in inches that range from zero inches to at least 8 inches.

6. The apparatus of claim 4 wherein inch ruler markings for the middle portion of the front side of the vertical axis are 1/16 inch increments.

7. The apparatus of claim 1 wherein the vertical axis and the horizontal axis are 1 1/2 inches in width.

8. The apparatus of claim 1 wherein an inner edge of a front side of the vertical axis is subdivided in one-quarter inches, beginning at 0 and extending to 34 one-quarter inches.

9. The apparatus of claim 1 wherein a first edge of a front side of the horizontal axis is subdivided in centimeters.

10. The apparatus of claim 9 wherein the first edge of the front side of the horizontal axis is subdivided in centimeters that range from zero centimeters to at least 20 centimeters.

11. The apparatus of claim 1 wherein a middle portion of a front side of the horizontal axis is subdivided in inches.

12. The apparatus of claim 11 wherein the middle portion of the front side of the horizontal axis is subdivided in inches that range from zero inches to at least 6 inches.

13. The apparatus of claim 11 wherein inch ruler markings for the middle portion of the front side of the horizontal axis are 1/16 inch increments.

14. The apparatus of claim 1 wherein an inner edge of a front side of the horizontal axis is subdivided in one-quarter inches, beginning at 0 and extending to 25 one-quarter inches.

15. An apparatus comprising:
a first L-shaped tool that has a vertical axis connected to a horizontal axis at an adjoining vertex, wherein the vertical axis and the horizontal axis are subdivided in measured increments;
a second L-shaped tool configured to work alone or in conjunction with the first L-shaped tool, wherein vertical and horizontal axes of the second L-shaped tool are not subdivided in measured increments; and
a circular shaped tool configured to work alone or in conjunction with the first L-shaped tool, wherein the circular shaped tool has measured edge markings distributed along a circumference of the circular shaped tool.

16. The apparatus of claim 15, wherein the second L-shaped tool has a vertical axis 22 centimeters in length and a horizontal axis 17 centimeters in length.

17. An apparatus comprising:
a circular shaped tool that has measured edge markings distributed along a circumference of the circular shaped tool; and
one or more radius lines that extend from a center of the circular tool to one or more of the measured edge markings, wherein at least one of the one or more radius lines is divided into spacings for at least two indicators for angle measure of degrees, sine, cosine, and tangent readings.

18. The apparatus of claim 17 wherein at least one of the one or more radius lines are divided into spacings for at least two ¼ inch radius holes equi-distance apart.

19. The apparatus of claim 17 wherein at least one of the one or more radius lines are divided into spacings for at least two ½ centimeter radius holes equi-distance apart.

20. The apparatus of claim 17 wherein the circular shaped tool has a circular hole at a center of the circular shaped tool.
